(19) United States
(12) Patent Application Publication
(10) Pub. No.: US 2008/0024292 A1
(43) Pub. Date: Jan. 31, 2008

(54) TILE

(76) Inventors: Stefano Rosi, Reggio Emilia (IT); Mattia Alberto Foracchia, Cavriago (Reggio Emilia) (IT); Ivan Gibertini, Barco (Reggio Emilia) (IT)

Correspondence Address: PEARNE & GORDON LLP, 1801 EAST 9TH STREET, SUITE 1200, CLEVELAND, OH, 44114-3108, US

(21) Appl. No.: 11/781,482

(22) Filed: Jul. 23, 2007

(30) Foreign Application Priority Data
Jul. 26, 2006 (IT) RE2006A000090

(51) Int. Cl. G05B 23/02

(52) U.S. Cl. 340/525

(57) ABSTRACT

The invention concerns a tile having a display surface exhibiting a plurality of teeth provided with two transversal surfaces. A visual symbol is reproduced on a first series of parallel surfaces, while on a second series of parallel surface, which are transversal to the surfaces of the first series, a further visual symbol is realised different to the first visual symbol. An observer views one or another of the visual symbols depending on his or her viewpoint.

### BACKGROUND OF THE INVENTION

The invention relates to a tile of a type comprising a structure developing substantially on a preferential lie plane and exhibiting at least a visible surface. The present invention is applicable in the construction sector, and in particular is usable in the places requiring special indications and signals, or in any room which requires special aesthetic enhancement or effects.

As is known, in some places, especially public places, signals and indications have to be provided to communicate safety information, such as for example the location of entrances, exits and/or emergency exits, or service communications relating to various zones of particular interest such as bathrooms, telephones, waiting areas and so on.

Generally, apart from the usual vertical indications applied on the walls and/or on special supports, the above-mentioned signs are also arranged horizontally on the flooring, so as to be visually perceived by the users while walking on the very same floors.

In particular, the prior art includes applications on the tiles and floorings of adhesives representing symbols, writing, messages, demarcation lines and the like, by means of which the directions to particular zones can be followed, and/or the location of the specific zones within sometimes vast areas found. Though these signals and/or indications are very widely used, the applicant has observed that they are not without drawbacks, especially in relation to the wear and tear on them.

In particular, it has been observed that adhesive signals are subject to a continual and progressive wear due to the constant passage of users thereon, not to mention trolleys and/or cleaning machines.

The constant deterioration of the signalling adhesive leads to the deformation thereof, which requires periodical substitution using new signalling adhesives. In this situation, the technical task at the root of the present invention is to design a tile which can obviate the described drawbacks.

It is therefore an important aim of the invention to provide a tile giving one or more permanent signals and/or visual indications which are not subject to deterioration.

A further aim of the present invention is to provide a tile which gives a double aesthetic effect, which varies whatever the angle of viewing thereof may be. The above-specified technical task and the specified aim are substantially attained by a tile in accordance with what is set out in the appended claims.

### SUMMARY OF THE INVENTION

The invention concerns a tile having a display surface exhibiting a plurality of teeth provided with two transversal surfaces. A visual symbol is reproduced on a first series of parallel surfaces, while on a second series of parallel surface, which are transversal to the surfaces of the first series, a further visual symbol is realised different to the first visual symbol. An observer views one or another of the visual symbols depending on his or her viewpoint.

### BRIEF DESCRIPTION OF THE DRAWINGS

A tile according to the invention will now be described by way of non-limiting example, accompanied by the figures of the drawings, in which:

FIG. 1 is a perspective view of the tile of the invention in a first embodiment of the present invention;

FIG. 2 is a further perspective view of the tile of the preceding figure;

FIG. 3 is a perspective view of the tile, in a second embodiment of the present invention;

FIG. 4 is a further perspective view of the tile of FIG. 3;

FIG. 5 is a section of the tile of the preceding figures made along line V-V of the preceding figures;

FIG. 6 is a further embodiment of a tile of the present invention shown in section.

### DESCRIPTION OF THE PREFERRED EMBODIMENTS

With reference to the figures of the drawings, 1 denotes the tile of the present invention in its entirety.

As can be seen in the accompanying figures, the tile 1 comprises a structure 2 which develops substantially on a preferential lie plane. The structure 2 exhibits an application surface 2a for application of the tile on a respective rest plane (not illustrated) of a surface (not illustrated) to be covered and a top surface 2b which is suitably finished in order to be visible internally of the place where the tile is located. The application surface 2a and the top surface 2b are laterally joined by four perimeter edges 2c which define the thickness of the tile 1.

With reference to the accompanying figures of the drawings, the top surface 2b exhibits at least a display portion 3, 4 extending along a substantially inclined direction with respect to the lie plane of the structure 2 and provided with at least a visual symbol 5, 6.

The at least a visual symbol 5, 6 can be in relief from the at least a display portion 3, 4 or can be inscribed on the at least a display portion 3, 4.

Further, the at least a visual symbol 5, 6 could be at least partially in relief while the remaining part could be inscribed in the at least a display portion 3, 4.

In more detail, the display surface 2b exhibits a first and a second display portion 3, 4 of which at least one develops in a substantially inclined direction with respect to the lie plane of the structure 2 of the tile 1 and exhibits at least a visible symbol 5, 6.

With reference to the embodiments illustrated in the accompanying figures, both the first and the second display portions 3, 4 advantageously develop each along at least a substantially inclined direction with respect to the lie plane of the structure 2 of the tile 1. Preferably the development direction of the first display portion 3 extends transversally with respect to the development direction of the second display portion 4 so that they face in opposite directions.

Both display portions 3, 4 are advantageously provided with a respective visual symbol 5, 6. The visual symbol 5 of the first display portion 3 is different with respect to the visual symbol 6 of the second display portion 4, so that from a point of observation which is external of the tile 1, different symbolic representations can be seen on a same tile 1.

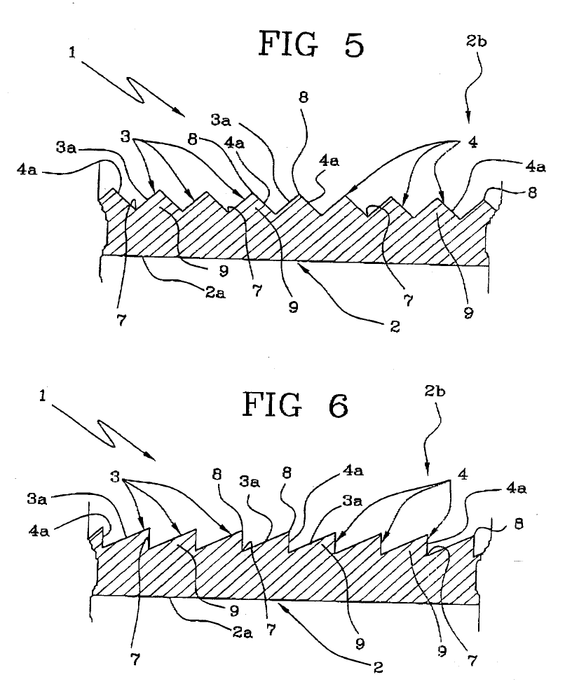

With special reference to the embodiments illustrated in the accompanying figures, each display portion 3, 4 exhibits a plurality of surfaces 3a, 4a which are substantially inclined with respect to the lie plane of the structure 2 of the tile 1. The surfaces 3a of the first display portion 3 are advantageously intercalated transversally with the surfaces 4a of the second display portion 4, thus constituting a continuous profile which is substantially corrugated. In other words, each surface 3a of the first display portion 3 is adjacent to at least a surface 4a of the second display portion 4 such as to define a plurality of channels 7 and reliefs 8 that are reciprocally intercalated (FIGS. 5 and 6). The surfaces 3a, of the first display portion 3 are preferably substantially parallel. Similarly, the surfaces 4a of the second display portion 4 are also reciprocally parallel. In this way, by observing the tile 1 from a raised observation point (with respect to the tile 1), for example the point of view of a person standing up, the observer perceives the plurality of surfaces 3a, 4a constituting the respective display portion 3, 4 substantially as single surfaces bearing the visual signal 5, 6.

Naturally, the viewpoint must be localised in one position, in substantially transversal directions thereto, in order to observe the surfaces 3a, 4a of the display portion 3, 4. In this situation, the visual symbol 5, 6 arranged on the other display portion 3, 4 is not perceived, as the surfaces 3a, 4a of the display portion 3, 4 are orientated transversally with respect to the surfaces 3a, 4a of the display portion 3, 4 in view.

To enable a correct viewing of each visual symbol 5, 6, each visual symbol 5, 6 is subdivided into a plurality of parts 5a, 6a, each corresponding to a respective surface 3a, 4a of the corresponding display portion 3, 4. In other words, each surface 3a, 4a of each display portion 3, 4 bears a part 5a, 6a of the corresponding visual symbol 5, 6 which corresponds to a horizontal strip thereof. Viewing the tile 1 from above, the surfaces compose the figures of the visual symbol 5, 6, defining the form and outlines thereof.

The visual symbols 5, 6 recreated on each display portion 3, 4 are preferably indications or direction signals by which people can be directed to entrances and/or exits or emergency exits from a closed space.

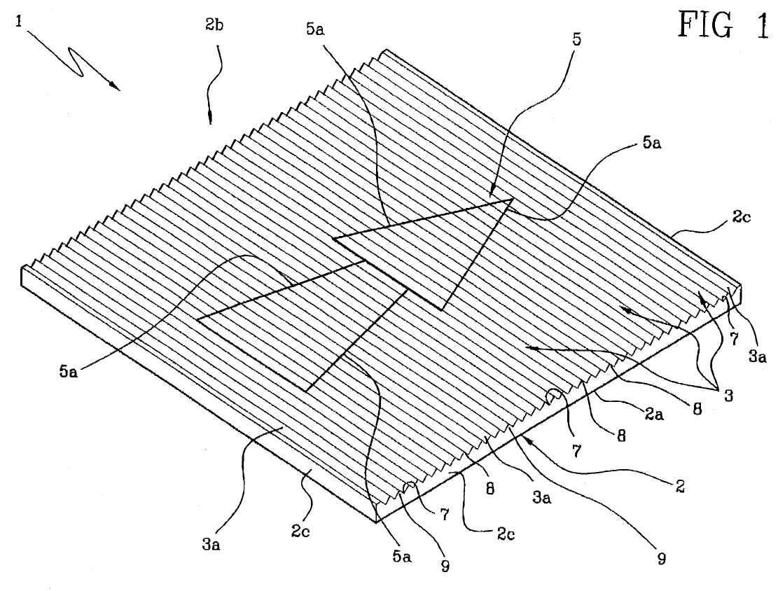

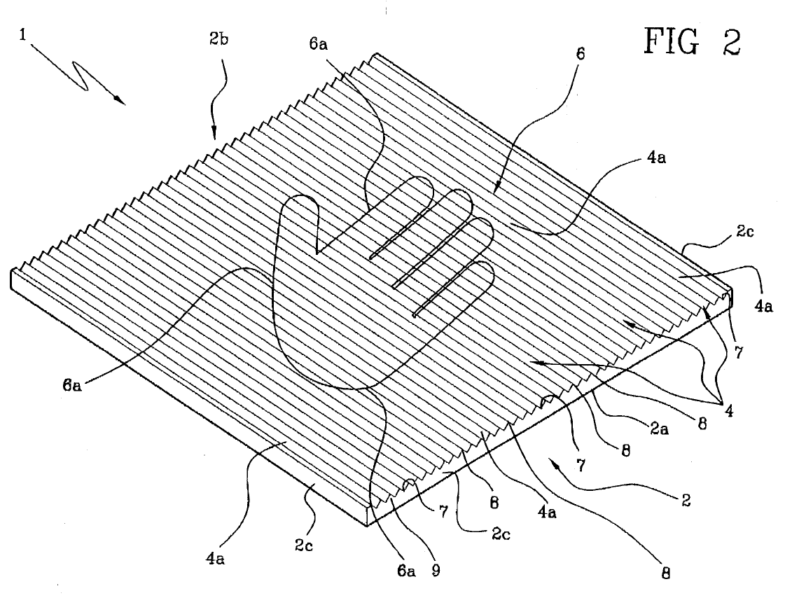

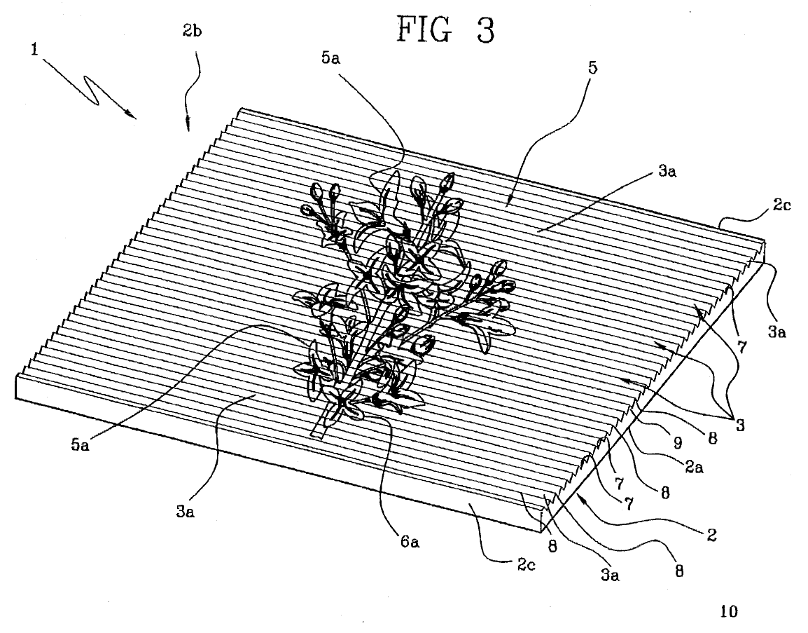

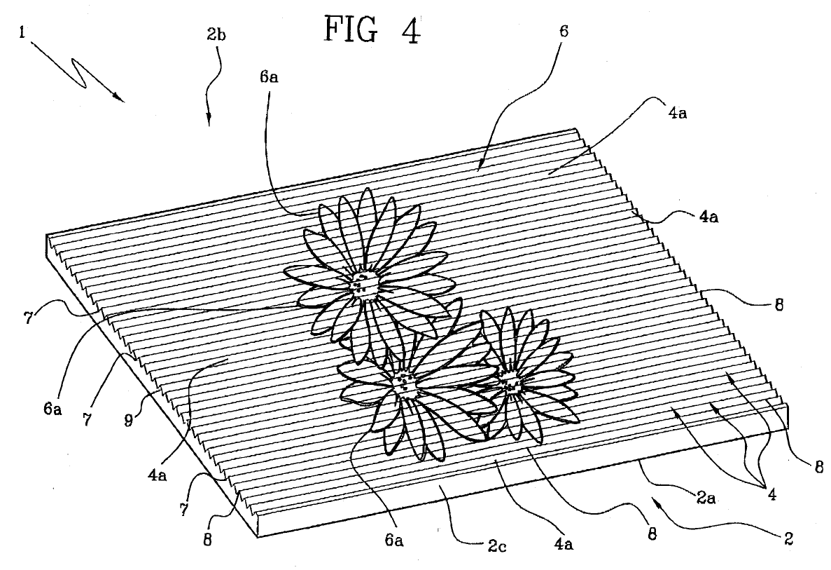

In the embodiment illustrated in FIG. 1, the tile 1 represented is provided with a first visual symbol 5, corresponding to an arrow to follow in order to reach a determined zone inside the place in which the tile 1 is arranged, while in FIG. 2, the tile 1, observed from the opposite side, bears an open palm image indicating that the viewer is following a wrong direction, or a stop sign. In the embodiment of FIGS. 3 and 4, the tile 1 is provided with two different finishes which provide two different aesthetic effects according to the point of observation of the tile 1.

With reference to the embodiments represented in FIGS. 5 and 6, the angle between consecutive adjacent surfaces 3a, 4a, is preferably comprised between 25° and 50°, with the result that the surfaces 3a, 4a define a series of identical teeth 9 having a profile in transversal section which is substantially triangular. In the embodiment illustrated in FIG. 5, the profile of the teeth 9 are preferably triangular, either equilateral or isosceles.

In the embodiment of FIG. 6, the teeth 9 exhibit, in transversal section, a substantially right-angled-triangular conformation, or a sawtooth section.

The above-described tile is advantageously realised starting from the formation of at least a prototype model. This model can be made using any known method, such as for example CNC (computer numerical control) incision of alloy sheet supports, or plaster, plastic and/or derivatives, or by manual modelling of plaster, wood, clay, wax and the like.

The ceramic prototype is then made, which can be realised by dropping, extrusion or pressing. The drop includes predisposing a two-sided die, with a bottom and a top surface, which is provided with a special hole for dropping the forming mixture paste.

Extrusion involves extruding the base shape, which is toothed, of the tile through the extrusion matrix and cutting the base shape when the desired length has been reached.

Pressing can be done using two different processes, dry-pressing and damp-pressing. Dry-pressing includes use of a press on a surface on which a punch is applied, bearing a negative of the image of the surface 2b of the tile 1 to produce. In particular, the negative punch is applied to the surface of the press to operate on any type of atomised paste used for realising the tile 1 and obtaining a series of ceramic tiles.

Damp-pressing consists in realising one press having two negative surfaces appropriately mounted on a press able to operate on a damp mix, such as for example a clayey paste.

When the dropping, extruding or pressing process is complete, the tile 1 obtained is dried and fired to stabilise the final shape.

Once the rigid ceramic support has been obtained, the support is subjected to one or two known decorating stages, such as for example manual decoration, screening, application of glazes, laser decoration and the like.

Concerning the graphic decorations, the two images destined to create the composition of the multi-view tile are now applied.

At first the images are transformed from a first format, for example 20×20 cm, to a second format, for example 10×20 cm, so that the image or symbol represented exhibits a desired deformation.

Thereafter, each image is transformed from a substantially full configuration to an alternating strip/space conformation, which brings it up to the previous 20×20 cm format.

The two strip/space images are united on the first format so that the full strips of one image are alternated with the full strips of the other image.

At this point, with the decoration to be applied on the tile obtained, the decoration is integrated on the drop die or press die or on the extrusion matrix to obtain the decorated tile directly during the stage of production thereof. Alternatively the decoration to be applied to the tile can be applied by manual decoration, by screening, application of glazes, laser decorations and the like, directly on the rigid ceramic support coming from the extrusion stage, or the pressing stage or the dropping stage.

The tile 1 of the present invention resolves the problems encountered in the prior art and provides important advantages.

Primarily the tile 1 enables a view of two visual symbols according to the viewpoint of the observer. This characteristics enables the tile 1 to provide two different or oppositely-intended signals, for example “proceed in this direction” and “stop, wrong direction”.

Also worthy of note is the fact that the symbols reported on the above-described tile are directed made in the structure of the tile and will therefore not suffer from problems of wear and tear. Consequently the symbols applied on the tile need no replacement or repair as they do not wear out over time. This leads to a considerable economic saving due to the elimination of the usual maintenance and/or replacement operations required when adhesive signalling is used.

Finally, the above-described tile enables special aesthetic effects to be realised both in public and in private places. In particular, the above-described tile exhibits a double ornamental effect which changes according to the viewpoint thereof.

1. A tile comprising a structure developing substantially on a preferential lie plane, the structure exhibiting at least a top surface destined to be on display, wherein the top surface exhibits at least a display portion extending along a substantially inclined direction with respect to the lie plane of the structure, the display portion being provided with at least a visual symbol.

2. The tile of claim 1, wherein the at least a visual symbol is in relief on the at least a display portion.

3. The tile of claim 1, wherein the at least a visual symbol is made by incision into the at least a display portion.

4. The tile of claim 1, wherein the at least a visual symbol is at least partially in relief on the at least a display portion, a remaining part of the at least a visual symbol being made by incision on the at least a display portion.

5. The tile of claim 1, wherein the top surface exhibits a first display portion and a second display portion, at least one of which first and second display portions developing in a substantially inclined direction with respect to the lie plane of the structure of the tile and exhibiting at least a visual symbol.

6. The tile of claim 5, wherein the first display portion and the second display portion each develop along a substantially inclined direction with respect to the lie plane of the structure of the tile, a development direction of the first display portion being transversal with respect to a development direction of the second display portion.

7. The tile of claim 6, wherein both the display portions are provided with at least a visual symbol.

8. The tile of claim 7, wherein the visual symbol on the first display portion (3) is different to the visual symbol on the second display portion.

9. The tile of claim 6, wherein each display portion exhibits a plurality of surfaces which are substantially inclined with respect to the lie plane of the structure of the tile, the surfaces of the first display portion being intercalated with the surfaces of the second display portion.

10. The tile of claim 9, wherein each surface of the first display portion is adjacent to at least a surface of the second display portion, the surfaces of the first display portion and the second display portion defining a plurality of channels and reliefs which are alternating.

11. The tile of claim 9, wherein the surfaces of the first display portion are substantially parallel.

12. The tile of claim 9, wherein the surfaces of the second display portion are substantially parallel.

13. The tile of claim 9, wherein each visual symbol is subdivided into a plurality of parts, each of which plurality of parts corresponds to a respective surface of a corresponding display portion.

14. The tile of claim 7, wherein at least one of the visual symbols represents an indication or a signal relating to a direction.

15. The tile of claim 7, wherein at least one of the visual symbols is an aesthetic decoration.
